(19) United States
(12) Patent Application Publication
(10) Pub. No.: US 2009/0116498 A1
(43) Pub. Date: May 7, 2009

(54) TESTING DATA SERVICE USING MOCA-TO-ETHERNET BRIDGE

(75) Inventors: Fung-Chang Huang, Herndon, VA (US); David H. Liu, Herndon, VA (US); Jeffrey F. Chu, Brambleton, VA (US); Charles E. Rothrauff, Sterling, VA (US); John Burch, McLean, VA (US)

Correspondence Address: FITZPATRICK CELLA HARPER & SCINTO, 30 ROCKEFELLER PLAZA, NEW YORK, NY, 10112, US

(73) Assignee: TELLABS VIENNA, INC., Naperville, IL (US)

(21) Appl. No.: 11/936,749

(22) Filed: Nov. 7, 2007

(51) Int. Cl. H04L 12/66

(52) U.S. Cl. 370/401

(57) ABSTRACT

A terminal apparatus includes an ethernet channel that transfers ethernet traffic between an ethernet port and an external network port during a normal operation mode of the apparatus, and a Multimedia over Cable Alliance (MoCA) channel that transfers MoCA traffic between a MoCA port and the external network port during the normal operation mode. The terminal apparatus also includes a test system that bridges the ethernet channel and the MoCA channel during a test mode of the apparatus. Ethernet traffic received by the ethernet port is converted to MoCA traffic and transferred to the MoCA port, and MoCA traffic received by the MoCA port is converted to ethernet traffic and transferred to the ethernet port.

### BACKGROUND

1. Field

Example aspects of the invention relate generally to a methods, systems, apparatuses, and programs for testing data service, and more particularly to testing a terminal apparatus that provides ethernet and Multimedia over Cable Alliance (MoCA), by bridging MoCA data traffic and ethernet data traffic.

2. Related Art

There is a growing demand in industry to provide multiple data services, such as voice, Internet, video, etc., to customers over a single communication network. For example, multiple services can be provided to a subscriber's premises through a fiber optic network that runs all the way into an individual home or business. Such fiber optic networks generally are referred to as fiber-to-the-home (FTTH), fiber-to-the-premises (FTTP), fiber-to-the-business (FTTB), fiber-to-the-node (FTTN), or fiber-to-the-curb (FTTC) networks and the like, depending on the specific application of interest. Such types of networks are also referred to herein generally as “FTTx networks”.

A representative typical FTTx network is shown in FIG. 1. A typical FTTx network includes one or more Optical Line Terminals (OLTs), which each include one or more Passive Optical Network (PON) cards, such as Broadband Passive Optical Network (BPON) cards and Gigabit Passive Optical Network (GPON) cards. In the case of a FTTP network (shown circled with a dashed line in FIG. 1), an OLT typically is communicatively coupled to one or more terminal devices, such as Optical Network Terminals (ONTs), via an Optical Distribution Network (ODN). Each ONT is communicatively coupled to one or more customer premises equipment (CPE). CPEs can include, for example, home gateway routers, DSL modems, telephone equipment, MoCA devices such as broadband home routers, computer networking devices such as an ethernet card of a personal computer, etc.

In a FTTC network, the ONU's are communicatively coupled to terminal devices, such as network terminals (NT), via the ODN and an Optical Network Unit (ONU). The NTs are communicatively coupled to CPE. NTs can be, for example, digital subscriber line (DSL) modems, asynchronous DSL (ADSL) modems, very high speed DSL (VDSL) modems, or the like.

In a FTTN network, each OLT typically can be communicatively coupled to one or more Remote Terminal (RT). The RTs are communicatively coupled to NTs that are communicatively coupled to CPE.

A typical FTTx network can provide subscribers with a plurality of services. In particular, equipment at a headend or central office couples the FTTx to a variety of external services, such as a Public Switched Telephone Network (PSTN), MoCA services, an external network, etc. Signals received from these services are transmitted to subscribers by converting the signals into optical signals and combining the optical signals onto a single optical fiber at a plurality of wavelengths.

In a typical FTTP network, for example, the optical signals are transmitted through the FTTP network to an optical splitter that splits the optical signals and transmits the individual optical signals over a single optical fiber to a subscriber's premises. At the subscriber's premises, the optical signals are converted into electrical signals by the terminal device, in this case an ONT, and separated into channels according to the services they provide. In this way, ONTs can provide multiple data services to a subscriber by separating the signals into channels corresponding to each service, and outputting the channeled signals through corresponding ports on the ONT. For example, some ONTs channel the signals from the optical network into a computer networking (such as ethernet) channel and a MoCA channel. In this case, the ONT includes an ethernet port and a MoCA port that are communicatively coupled to CPE, such as an ethernet card of a personal computer and a broadband home router (BHR), respectively.

In typical FTTC and FTTN networks, the optical signal is converted to an electrical signal by either an Optical Network Unit (ONU) (in the case of FTTC) or a Remote Terminal (RT) (in the case of FTTN), before being provided to a subscriber's premises.

Manufacturers of terminal devices, such as ONTs, NTs, etc., can expend a significant amount of capital in testing the devices prior to shipment. For example, functional testing of some terminal devices, such as ONTs, can require building an extensive test bed of expensive equipment. In particular, functionally testing an ONT typically requires set up of a full suite of network equipment to model a complete end-to-end FTTP network service, such as the one shown circled with a dashed line in FIG. 1. The suite of equipment can include an OLT network equipment equipped with a PON and ATM optical cards, as well as data test equipment supporting ATM switch for broadband pass optical network (BPON) and a gige interface for GPON applications. In addition to a high capital outlay for the equipment, the conventional test setup typically results in a labor-intensive configuration required to control the tests.

### BRIEF DESCRIPTION

The foregoing can be addressed with a method, apparatus, system, and computer program for testing a terminal device, and also by terminal device that operates in accordance with the method.

In one example embodiment of the invention, a terminal apparatus includes an ethernet channel that transfers ethernet traffic between an ethernet port and an external network port, such as a passive optical network port, during a normal operation mode of the apparatus, and a MoCA channel that transfers MoCA traffic between a MoCA port and the external network port during the normal operation mode. The terminal apparatus also includes a test system that bridges the ethernet channel and the MoCA channel during a test mode of the apparatus. Ethernet traffic received by the ethernet port is converted to MoCA traffic and transferred to the MoCA port, and MoCA traffic received by the MoCA port is converted to ethernet traffic and transferred to the ethernet port.

In another example embodiment of the invention, the bridging the ethernet channel and the MoCA channel includes buffering received traffic and determining a source address of the received traffic.

In another example embodiment of the invention, the terminal apparatus includes a test port that receives test instruction data for initializing the test system from an external test apparatus.

In yet another example embodiment, bridged traffic between the ethernet port and the MoCA port flows bidirectionally.

In still another example embodiment of the invention, a system for testing a terminal apparatus includes a MoCA device, such as a broadband home router, coupled to the MoCA port of the apparatus, and a test device coupled to (i) the ethernet port of the apparatus, and (ii) the MoCA device. The test device transmits test data to the ethernet port during the test mode, and receives feedback data corresponding to the test data from the coupling with the MoCA device.

The example embodiments of the invention may be embodied in, without limitation, a method, apparatus, or computer-executable program instructions.

### BRIEF DESCRIPTION OF THE DRAWINGS

FIG. 1 is a block diagram of a typical FTTx network.

FIG. 2 is a more detailed diagram of a typical FTTx network.

FIG. 3 is a block diagram of a terminal device according to one example embodiment of the invention.

FIG. 4 is a block diagram showing the terminal device of FIG. 3 in an example normal operation environment.

FIG. 5 is a block diagram showing the terminal device FIG. 3 in an example test environment according to one example embodiment of the invention.

FIG. 6 is a sequence diagram of a test operation mode according to one example embodiment of the invention.

FIG. 7 is a flow chart of a method of bridging data channels according to one example embodiment of the invention.

FIG. 8 is a block diagram of a data processing system according to one example embodiment of the invention.

FIG. 9 is a logical diagram of functional modules in accordance with an example embodiment of the invention.

### DETAILED DESCRIPTION

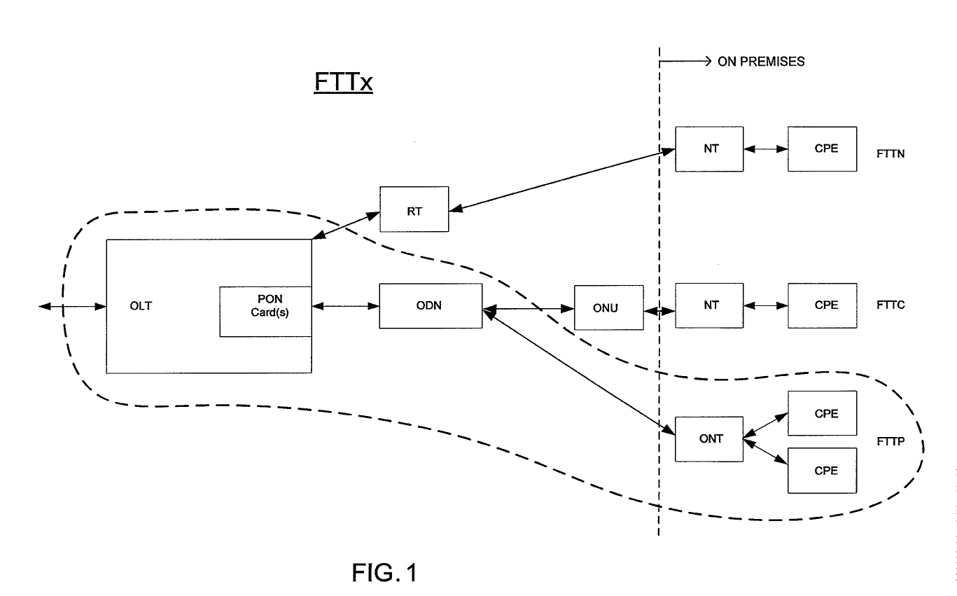

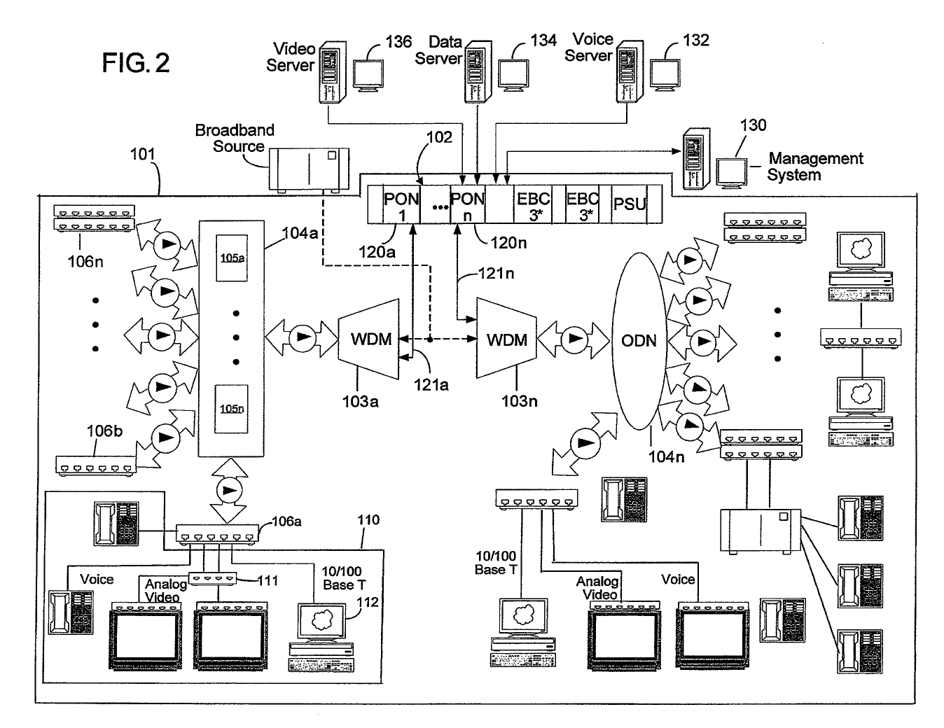

FIG. 2 is a more detailed diagram of a typical FTTx network, such as that shown in FIG. 1. A PON 101 of the system includes an OLT 102, wavelength division multiplexers 103a-n, ODN devices 104a-n, ODN device splitters (e.g., 105a-n associated with ODN device 104a), ONTs (e.g., 106-n corresponding to ODN device splitters 105a-n), and customer premises equipment (e.g., 110). OLT 102 includes PON cards 120a-n (which could be, for example, BPON cards, GPON cards, etc.), each of which provides an optical feed (121a-n) to ODN devices 104a-n. Optical feed 121a, for example, is distributed through corresponding ODN device 104a by separate ODN device splitters 105a-n to respective ONTs 106a-n, in order to provide communications to and from customer premises equipment 110 operably coupled to a port of the ONT.

The PON 101 may be deployed for fiber-to-the-business (FTTB), fiber-to-the-curb (FTTC), and fiber-to-the-home (FTTH) applications, for example. The optical feeds 121a-n in PON 101 may operate at bandwidths such as 155 Mb/sec, 622 Mb/sec, 1.25 Gb/sec, and 2.5 Gb/sec or any other desired bandwidth implementations. The PON 101 may incorporate, for example, ATM communications, broadband services such as Ethernet access and video distribution, MoCA services, Ethernet point-to-multipoint topologies, BPON communications, GPON communications, Ethernet Passive Optical Network (EPON) communications, and native communications of data and time division multiplex (TDM) formats. Customer premises equipment (e.g., 110) which can receive and provide communications in the PON 101 may include standard telephones (e.g., Public Switched Telephone Network (PSTN)), Internet Protocol telephones, Ethernet units, broadband home routers (e.g., 111), computer terminals (e.g., 112), digital subscriber line connections, cable modems, wireless access, as well as any other type of customer premise equipment.

PON 101 can include one or more different types of ONTs (e.g., 106a-n). Each ONT 106a-n, for example, is operably coupled with an ODN device 104a through associated ODN device splitters 105a-n via a data port. Each ODN device 104a-n in turn communicates with an associated PON card 120a-n through respective wavelength division multiplexers 103a-n. Wavelength division multiplexers 103a-n are optional components which are used when video services are provided. Communications between the ODN devices 104a-n and the OLT 102 occur over a downstream wavelength and an upstream wavelength. The downstream communications from the OLT 102 to the ODN devices 104a-n may be provided at, for example, 622 megabytes per second, which is shared across all ONTs connected to the ODN devices 104a-n. The upstream communications from the ODN devices 104a-n to the PON cards 120a-n may be provided at, for example, 155 megabytes per second, which is shared among all ONTs connected to ODN devices 104a-n, although the invention is not limited to those specific types of downstream and upstream communications only, and may also include the types of example communications referred to above or any other suitable types of communications.

FIG. 2 further illustrates OLT 102 managed by an element management system (EMS) 130. Since OLT 102 includes PON cards 120a-n, each PON card 120a-n is also managed by EMS 130. As such, a single EMS manages all PON cards within a PON.

A single EMS, however, may manage or otherwise be associated with more than one PON. As such, a single EMS is not limited to managing PON cards within a single PON, but may manage PON cards from several PONs. In other systems, more than one EMS can be employed to manage one or more PON cards within a single PON or plural PONs.

FIG. 2 also illustrates a plurality of servers, such as, for example a server 132 that supports voice applications, a server 134 that supports data applications, and a server 136 that supports video applications, although in other systems the functionality of those servers may be performed by only a single server or by a combination of servers. In still other systems, the servers 132, 134, 136, and/or EMS 130 can be formed by a single server device or a combination of server devices, or no EMS 130 need be provided and the functionality of the EMS 130 can be provided by the servers 132, 134, and 136.

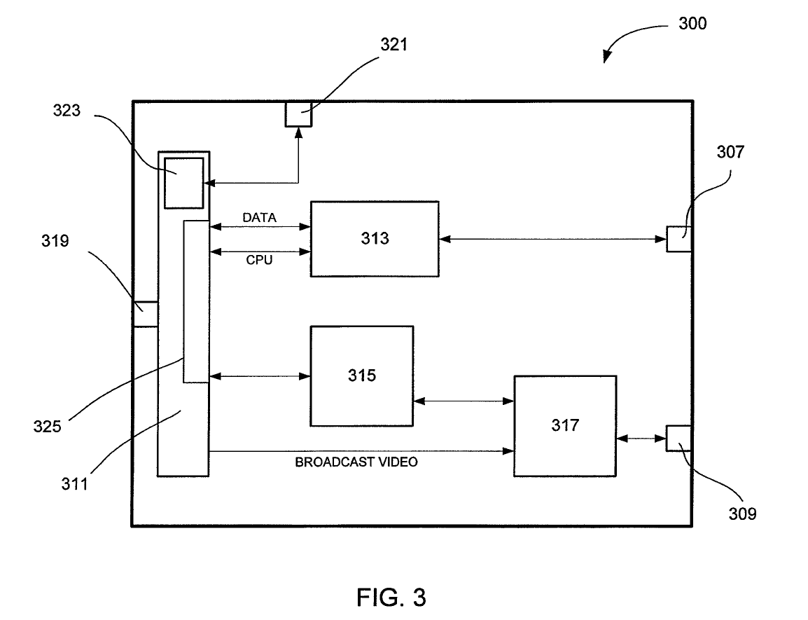

FIG. 3 is a block diagram of one example embodiment of the invention. In particular, FIG. 3 shows an ONT 300. ONT 300 includes an ethernet port 307 and a MoCA port 309, for transmitting and receiving ethernet and MoCA data, respectively. Ethernet port 307 can be, for example, a RJ45-type port, a thinnet BNC, etc. MoCA port 309 can be, for example, an F-type connector. ONT 300 also includes a routing unit 311, an ethernet controller 313, a MoCA chipset 315, and a diplexer 317. ONT 300 also includes an optical port 319 for transmitting and receiving optical signals, and a test port 321 for transmitting and receiving test data and commands. Routing unit 311 is coupled to ethernet controller 313 with a DATA line and a CPU line. Routing unit 311 includes a test system 323 and a field programmable gate array (FPGA) 325 that is controllable by test system 323 to implement a test operation mode which will be described in detail below. Packets coming from ethernet data PHY flow through a GMII interface (data line) into a GMII MUX in FPGA 325. A CPU controller (not shown) manages the scheduling and buffering.

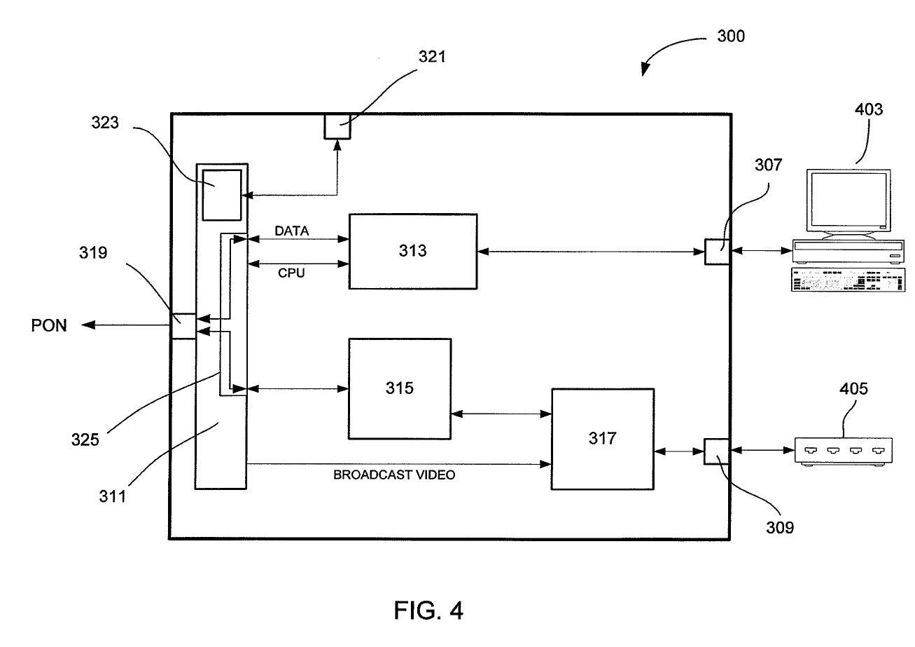

FIG. 4 is a block diagram showing ONT 300 in an example operating environment, in which ONT 300 is operating in a normal operation mode. In particular, FIG. 4 shows ONT 300 coupled to an ethernet-capable personal computer (PC) 403 and a BHR 405, through ethernet port 307 and MoCA port 309, respectively. Optical port 319 is coupled to a Passive Optical Network (PON).

A normal operation mode of ONT 300 will now be described. Normal operation occurs, for example, after ONT 300 is installed at a customer's premises and activated to provide the customer with ethernet and MoCA services through the service provider's PON.

During normal operation, ONT 300 transmits and receives optical signals corresponding to an ethernet service and a MoCA service, and receives broadcast video signals, through optical port 319, transmits and receives electrical signals corresponding to the ethernet service through ethernet port 307, transmits and receives electrical signals corresponding to the MoCA service through MoCA port 309, and transmits broadcast video signals through MoCA port 309.

For example, when receiving optical signals corresponding to ethernet service at optical port 319, routing unit 311 converts the optical signals into electrical signals, in this case ethernet data. Then, routing unit 311 routes the ethernet data through FPGA 325 to ethernet controller 313, which processes the ethernet data and forwards it to PC 303 through ethernet port 307. Conversely, when ONT 300 receives ethernet data signals at ethernet port 307, ethernet controller 313 receives and processes the ethernet data, and forwards the data to routing unit 311 through FPGA 325. Routing unit 311 converts the ethernet data to optical signals and transmits the optical signals via optical port 319.

Similarly, when receiving MoCA signals corresponding to MoCA service at optical port 319, routing unit 311 converts the MoCA signals into electrical signals, in this case MoCA data. Then, routing unit 311 routes the MoCA data through FPGA 325 to MoCA chipset 315, which processes the MoCA data and forwards it to diplexer 317. Diplexer 317 combines the MoCA data with any broadcast video signals and transmits the combined signal to broadband home router 305 through MoCA port 309. BHR 305 routes signals through a MoCA network to the appropriate MoCA enabled device on the customer's premises. Conversely, when ONT 300 receives MoCA data signals at MoCA port 309, diplexer 317 forwards the MoCA data signals to MoCA chipset 315. MoCA chipset 315 processes the MoCA data and forwards it to routing unit 311 through FPGA 325. Routing unit 311 converts the MoCA data into optical signals and transmits the optical signals via optical port 319.

Thus, flow of the ethernet data within ONT 300 occurs in an ethernet channel, i.e., ethernet data flows through optical port 319, routing unit 311 (including FPGA 325), ethernet controller 313, and ethernet port 307. Similarly, the flow of MoCA data within ONT 300 occurs in a MoCA channel, i.e., MoCA data flows through optical port 319, routing unit 311 (including FPGA 325), MoCA chipset 315, diplexer 317, and MoCA port 309. In particular, during normal operation FPGA 325 is programmed to channel ethernet data between optical port 319 and ethernet port 307, and to channel MoCA data between optical port 319 and MoCA port 309.

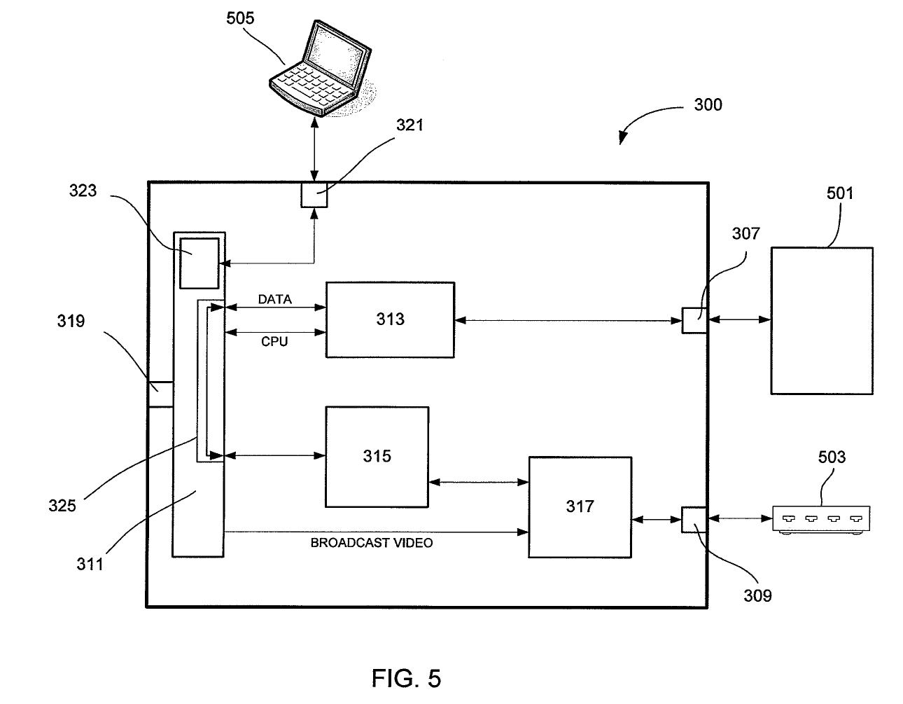

A testing method, environment, and mode of operation according to one example embodiment of the invention will now be described with reference to FIGS. 5 to 7.

FIG. 5 is a block diagram of test environment according to one example embodiment of the invention, in which ONT 300 is operating in a test operation mode. The test operation mode could be activated, for example, during functional testing of ONT 300 at the manufacturer's testing facilities.

FIG. 5 shows ONT 300 coupled to a test device 501 through ethernet port 307, and coupled to a broadband home router 503 through MoCA port 309. Test device 501 is further coupled to broadband home router 503. Test device 501 can be any ethernet-capable device, for example, a personal computer, a specialized ethernet test device, etc. ONT 300 is also coupled to a laptop computer 505 through test port 321.

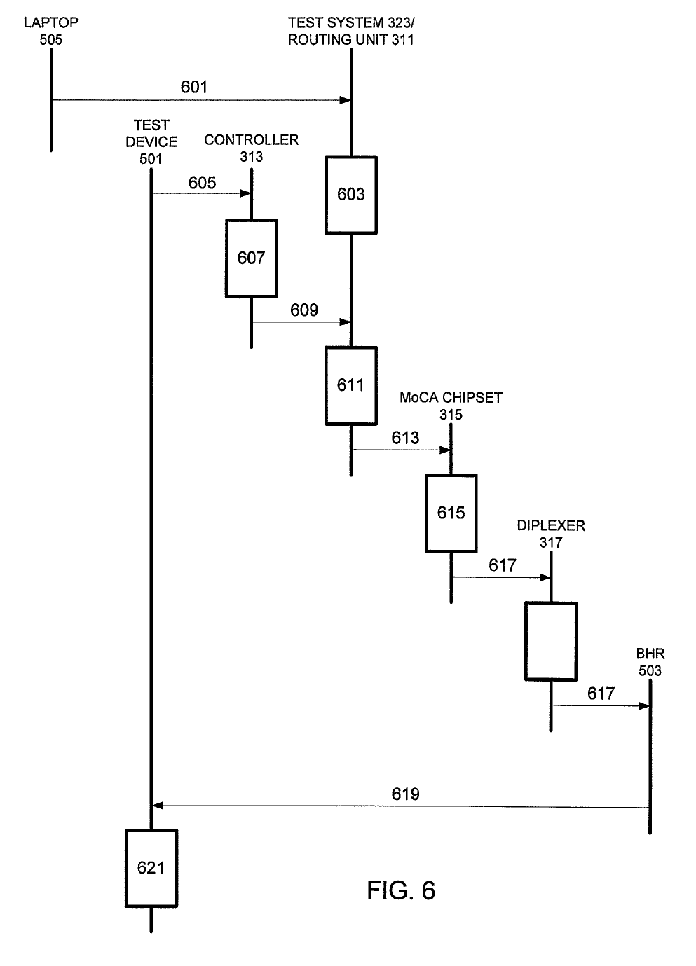

FIG. 6 is a sequence diagram of a testing method according to one example embodiment of the invention. An operator activates the test operation mode of ONT 300 using laptop 505 by transmitting an activation command 601 to test system 323 via test port 321. Laptop 505 can issue additional commands, such as debug commands, and send and receive other data, such as test parameters, during the test operation mode. Upon receiving activation command 601, test system 323 initializes (603) a data bridge function of routing unit 311 to bridge the ethernet channel and the MoCA channel during the test operation mode. In particular, test system 323 reprograms FPGA 325 to channel data between ethernet port 307 and MoCA port 309, i.e., bridge the ethernet channel and the MoCA channel. Consequently, transmission and reception of data through optical port 319 is suspended during the test operation mode.

Once the test operation mode is activated and the data bridge function of routing unit 311 is initialized, test device 501 transmits test data 605, which is received by ethernet controller 313 via ethernet port 307. Test data 605 is in the form of ethernet data. Ethernet controller 313 processes (607) test data 605 and transmits the processed data 609 to routing unit 311. At block 611, routing unit 311 converts processed data 609 from ethernet data to MoCA data, and routes the converted MoCA test data 613 to MoCA chipset 315. MoCA chipset 315 processes (615) data 613, and transmits the processed data 617 to diplexer 317. Diplexer 317 forwards processed data 617, without diplexing, to broadband home router 503 via MoCA port 309, since no broadcast video signal is received during the test operation mode. BHR 503 transmits feedback data 619 to test device 501 via the coupling between the two devices. Test device 501 processes (621) feedback data 619 to determine information about ONT 300, such as the level of operability of the ethernet channel and the MoCA channel.

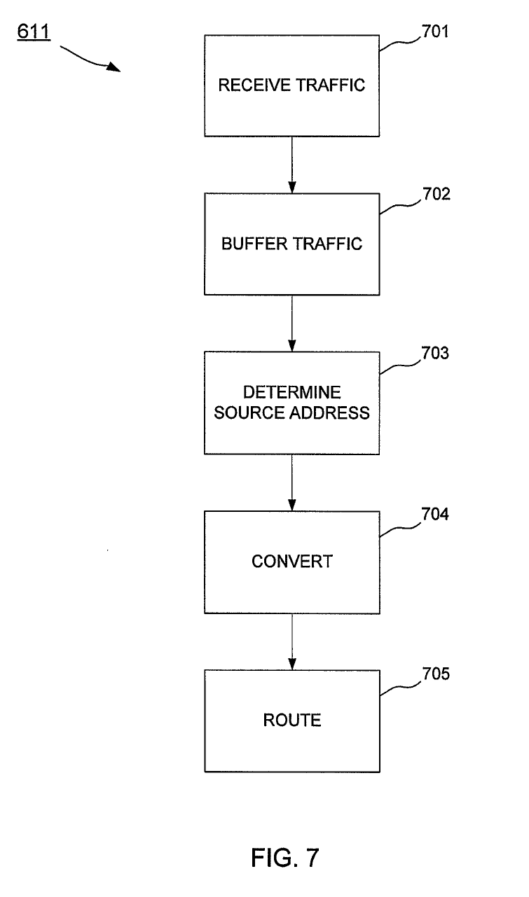

FIG. 7 is a flow chart of a method of bridging an ethernet channel and a MoCA channel according to one example embodiment of the invention. Specifically, FIG. 7 shows the method of conversion and routing 611 performed by routing unit 311 in more detail.

During test operation mode, routing unit 311 receives (701) processed data 609 from ethernet controller 313. Processed data 609 is in the form of ethernet packets, which entered ONT 300 via ethernet port 307 as unprocessed test packets 605 over the ethernet physical layer (PHY) and were processed by ethernet controller 323. Processed test packets 609 are received across a Gigabit Media Independent Interface (GMII) of routing unit 311, and enter a GMII multiplexer (MUX) within routing unit 311. Routing unit 311 buffers (702) the test packets 609 in a memory (not shown). The source MAC address of packets 609 is then determined (703). Routing unit 311 converts (704) test packets 609 into MoCA form, as MoCA test packets 613. From the buffer, MoCA packets 613 travel in parallel along two different paths within routing unit 311. The first path is out of the GMII MUX and into a GMII media access controller (MAC) (not shown). That path terminates within routing unit 311 upstream of the MAC, based on the determined source MAC address, and after the MoCA driver is notified (if the source MAC address is new). The second path is out of the GMII MUX and into a GMII-to-PCI bridge (not shown) within FPGA 325. There the packets enter a downstream FIFO, in a similar way that downstream packets normally would. Routing unit 311 routes (705) packets 613 to MoCA chipset 315. More particularly, the packets then are transferred into the PCI domain and are eventually DMA'd from FPGA 325 to a MoCA PHY by MoCA chipset 315. From that point, MoCA chipset 315 transmits MoCA packets 613 as described above.

Conversely, one skilled in the art will readily recognize that a similar method can be used to route MoCA traffic received at MoCA port 309 to ethernet port 307. For example, the MoCA protocol supports flow of data formatted using a transport protocol by providing convergence layer functionality to map control and data service to the MoCA MAC layer. When the ethernet convergence layer passes an ethernet packet to the MoCA, it can perform the functions of packet encapsulation and forwarding to the appropriate MoCA interface. Upon receiving a data packet from the MoCA, the ethernet convergence layer can strip any MoCA encapsulation and forward the received MAC Ethernet data transmission to the upper layer. Accordingly, the flow of data during the test operation mode can be bi-directional.

In contrast to a typical conventional functional test setup, a full suite of network equipment connected to the optical port is not required, since the test operation mode of the present example embodiment obviates the need for a complete end-to-end FTTP network service, such as the one shown circled by a dashed line in FIG. 1, during testing.

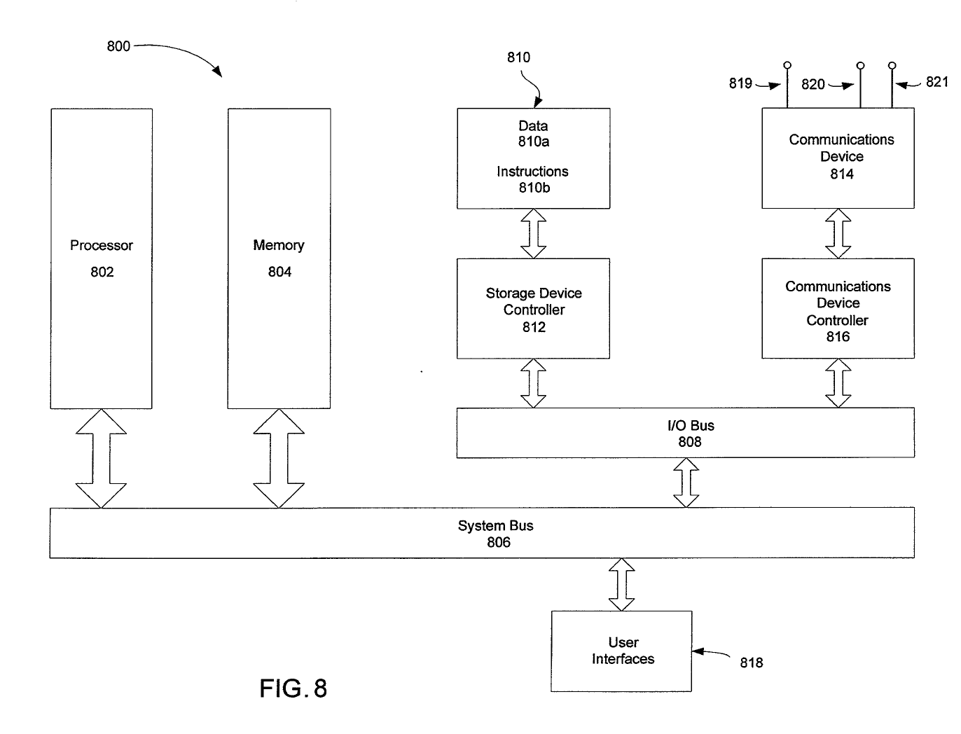

FIG. 8 is an architecture diagram of an example data processing system 800 which, according to an example embodiment, can form individual ones of the components of ONT 300 and/or other types of terminal devices. Data processing system 800 includes a processor 802 coupled to a memory 804 via system bus 806. Processor 802 is also coupled to external Input/Output (I/O) devices (not shown) via the system bus 806 and an I/O bus 808, and at least one input/output user interface 818. Processor 802 may be further coupled to a communications device 814 via a communications device controller 816 coupled to the I/O bus 808. Processor 802 uses the communications device 814 to communicate with a network, such as, for example, a network as shown in any of FIGS. 1 and 2. In the case of at least ONT 300, device 814 has data port 819 operably coupled to a network (e.g., PON 101) for sending and receiving data, and services data ports 820 and 821 operably coupled to customer premises equipment (e.g., PC 403 and BHR 405 during normal operation, test device 501 and BHR 503 during test operation mode) for sending and receiving ethernet and MoCA data, but device 814 may also have one or more additional input and output ports. A storage device 810 having a computer-readable medium is coupled to the processor 802 via a storage device controller 812 and the I/O bus 808 and the system bus 806. The storage device 810 is used by the processor 802 and controller 812 to store and read/write data 810a, and to store program instructions 810b used to implement the procedures described above in connection with FIGS. 6 and/or 7. The storage device 810 also stores various routines and operating programs (e.g., Microsoft Windows, UNIX/LINUX, or OS/2) that are used by the processor 802 for controlling the overall operation of the system 800. At least one of the programs (e.g., Microsoft Winsock) stored in storage device 810 can adhere to TCP/IP protocols (i.e., includes a TCP/IP stack), for implementing a known method for connecting to the Internet or another network.

In operation, processor 802 loads the program instructions 810b from the storage device 810 into the memory 804. Processor 802 then executes the loaded program instructions 810b to perform any of the example methods described above, for operating the system 800.

In the case of a terminal device, the instructions 810b stored in the storage device 810 also include instructions which, when executed by the processor 802, enable the bridging of an ethernet channel and a MoCA channel.

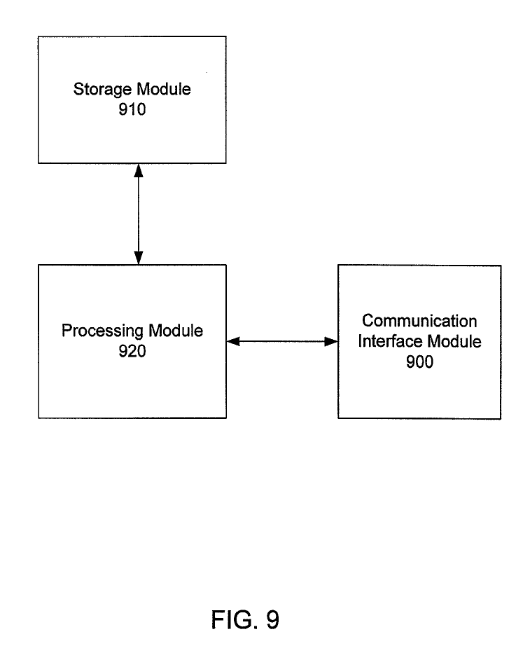

FIG. 9 is a logical diagram of modules in accordance with an example embodiment of the invention. The modules may be of a data processing system or device 800, which, according to an example embodiment, can form individual ones of the components of ONT 300 and/or other types of terminal devices. The modules may be implemented using hardcoded computational modules or other types of circuitry, or a combination of software and circuitry modules.

Communication interface module 900 controls communication device 814 by processing interface commands. Interface commands may be, for example, commands to send data, commands to communicatively couple with another device, or any other suitable type of interface command.

Storage device module 910 stores and retrieves data in response to requests from processing module 920.

In the case of terminal devices such as ONT hundred, processing module 920 performs the procedures as described above in connection with FIGS. 6 and 7.

By virtue of the example methods, system, devices, and control logic of the invention described herein, a terminal device can be tested without the need for a complete end-to-end FTTP network service.

It should be noted that although the invention is described in the context of an Optical Network Terminal, broadly construed, the invention can also be used with any other suitable types of terminal devices.

Although this invention has been described in certain specific example embodiments, many additional modifications and variations would be apparent to those skilled in the art. It is therefore to be understood that this invention may be practiced otherwise than as specifically described. Thus, the example embodiments of the invention should be considered in all respects as illustrative and not restrictive, the scope of the invention to be determined by any claims supportable by this application and the claims' equivalents rather than the foregoing description.

For example, the test operation mode could be activated and controlled by means other than an external laptop computer, such as by connecting a phone/buttset keypad to a plain old telephone service (POTS) line of a terminal device and inputting Dual Tone-MultiFrequency (DTMF) signals to activate a menu with options including enable test operation mode, disable test operation mode, current status, etc. In another example embodiment, internal or external buttons, switches, dials, etc., on a terminal apparatus could allow activation and control of the test operation mode.

Software embodiments of the invention may be provided as a computer program product, or software, that may include an article of manufacture on a machine accessible or computer-readable medium (memory) having instructions. The instructions on the machine accessible or computer-readable medium may be used to program a computer system or other electronic device. The computer-readable medium may include, but is not limited to, floppy diskettes, optical disks, CD-ROMs, and magneto-optical disks or other types of media/computer-readable medium suitable for storing or transmitting electronic instructions. The techniques described herein are not limited to any particular software configuration. They may find applicability in any computing or processing environment. The terms “machine accessible medium” or “computer-readable medium” used herein shall include any medium that is capable of storing, encoding, or transmitting a sequence of instructions or data for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and advantages of the invention, are presented for example purposes only. The architecture of the invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the invention in any way. It is also to be understood that the steps and processes recited in the claims need not be performed in the order presented.

What is claimed is:

1. A terminal apparatus comprising:
an ethernet channel that transfers ethernet traffic between an ethernet port and an external network port during a normal operation mode of the apparatus;
a Multimedia over Cable Alliance (MoCA) channel that transfers MoCA traffic between a MoCA port and the external network port during the normal operation mode; and
a test system that bridges the ethernet channel and the MoCA channel during a test mode of the apparatus, wherein ethernet traffic received by the ethernet port is converted to MoCA traffic and transferred to the MoCA port, and MoCA traffic received by the MoCA port is converted to ethernet traffic and transferred to the ethernet port.

2. The apparatus of claim 1, wherein the external network port is a passive optical network (PON) port.

3. The apparatus of claim 1, wherein the bridging the ethernet channel and the MoCA channel includes buffering received traffic and determining a source address of the received traffic.

4. The apparatus of claim 1, further comprising:
a test port that receives test instruction data for initializing the test system from an external test apparatus.

5. The apparatus of claim 1, wherein bridged traffic between the ethernet port and the MoCA port flows bidirectionally.

6. A system for testing the terminal apparatus of claim 1, wherein a MoCA device is coupled to the MoCA port of the terminal apparatus, a test device is coupled to (i) the ethernet port of the terminal apparatus, and (ii) the MoCA device, and the test device transmits test data to the ethernet port during the test mode, and receives feedback data corresponding to the test data from the coupling with the MoCA device.

7. The system of claim 6, wherein the MoCA device is a broadband home router.

8. A method of testing a terminal apparatus that includes an ethernet channel that transfers ethernet traffic between an ethernet port and an external network port during a normal operation mode of the apparatus, and a Multimedia over Cable Alliance (MoCA) channel that transfers MoCA traffic between a MoCA port and the external network port during the normal operation mode, the method comprising:
bridging the ethernet channel and the MoCA channel, wherein ethernet traffic received by the ethernet port is converted to MoCA traffic and transferred to the MoCA port, and MoCA traffic received by the MoCA port is converted to ethernet traffic and transferred to the ethernet port.

9. The method of claim 8, wherein the external network port is a passive optical network (PON) port.

10. The method of claim 8, wherein the bridging the ethernet channel and the MoCA channel comprises:
buffering received traffic; and
determining a source address of the received traffic.

11. The method of claim 8, further comprising:
receiving test instruction data for initializing testing from an external test apparatus.

12. The method of claim 8, wherein bridged traffic between the ethernet port and the MoCA port flows bidirectionally.

13. The method of claim 8, further comprising:
coupling a MoCA device to the MoCA port of the apparatus; and
coupling a test device to (i) the ethernet port of the apparatus, and (ii) the MoCA device,
wherein the test device transmits test data to the ethernet port during the test mode, and receives feedback data corresponding to the test data from the coupling with the MoCA device.

14. The method of claim 13, wherein the MoCA device is a broadband home router.

15. A computer-readable storage medium storing computer-executable program instructions for testing a terminal apparatus that includes an ethernet channel that transfers ethernet traffic between an ethernet port and an external network port during a normal operation mode of the apparatus, and a Multimedia over Cable Alliance (MoCA) channel that transfers MoCA traffic between a MoCA port and the external network port during the normal operation mode, the program instructions comprising:
code to bridge the ethernet channel and the MoCA channel, wherein ethernet traffic received by the ethernet port is converted to MoCA traffic and transferred to the MoCA port, and MoCA traffic received by the MoCA port is converted to ethernet traffic and transferred to the ethernet port.

16. The storage medium of claim 15, wherein the external network port is a passive optical network (PON) port.

17. The storage medium of claim 15, wherein the code to bridge comprises:
code to buffer the ethernet traffic; and
code to determine a source address of the ethernet traffic.

18. The storage medium of claim 15, wherein the program instructions further comprise:
code to receive test instruction data for initializing testing from an external test apparatus.

19. The storage medium of claim 15, wherein bridged traffic between the ethernet port and the MoCA port flows bidirectionally.

20. The storage medium of claim 15, wherein the program instructions further comprise:
code to couple a MoCA device to the MoCA port of the apparatus; and
code to couple a test device to (i) the ethernet port of the apparatus, and (ii) the MoCA device,
wherein the test device transmits test data to the ethernet port during the test mode, and receives feedback data corresponding to the test data from the coupling with the MoCA device.

21. The storage medium of claim 20, wherein the MoCA device is a broadband home router.
